(19) United States
(12) Patent Application Publication
(10) Pub. No.: US 2008/0289939 A1
(43) Pub. Date: Nov. 27, 2008

(54) Method and Apparatus for Activating a Toggle Power Switch Located on a Wall or Other Structure

(76) Inventor: James W. Davidson, JR., San Jose, CA (US)

Correspondence Address: SAWYER LAW GROUP LLP, 2465 E. Bayshore Road, Suite No. 406, PALO ALTO, CA, 94303, US

(21) Appl. No.: 11/752,223

(22) Filed: May 22, 2007

(51) Int. Cl. H01H 3/20

(52) U.S. Cl. 200/331

(57) ABSTRACT

An actuator mechanism for activating a power switch fixedly attached to a wall is provided. The actuator mechanism includes a remote power switch that is portably locatable on the wall separate from the power switch that is fixedly attached to the wall. The remote power switch is operable to be toggled to a first power state and a second power state. The actuator mechanism further includes an extension arm that extends from the power switch in a substantially horizontal direction. Responsive to a user toggling the remote power switch from the first power state to the second power state, the extension arm rotates to activate or deactivate the power switch fixedly attached to the wall.

### FIELD OF THE INVENTION

The present invention relates generally to techniques for activating a toggle power switch.

### BACKGROUND OF THE INVENTION

Toggle power switches (e.g., light switches) are typically fixed at pre-determined locations on a wall. For example, FIG. 1 illustrates a typical room 100 including a toggle power switch 102 located at a fixed position on a wall 104 of the room 100. The fixed location of the toggle power switch 102 on the wall 104 generally prevents a person (e.g., an interior decorator or designer) from placing large furniture or appliances at a location in the room 100 that may cover (and prevent access to) the toggle power switch 102. However, an interior decorator may not always have a choice as to where particular furniture is placed in a given room—e.g., due to a picky client or size constraints of a room—and in some cases, furniture needs to be placed at a location that prevents access to a toggle power switch. For example, FIG. 2 illustrates a book shelf 106 that is placed at a location in the room 100 that covers and prevents access to the toggle power switch 102.

### BRIEF SUMMARY OF THE INVENTION

In general, in one aspect, this specification describes an actuator mechanism for activating a power switch fixedly attached to a wall. The actuator mechanism includes a remote power switch that is portably locatable on the wall separate from the power switch that is fixedly attached to the wall. The remote power switch is operable to be toggled to a first power state and a second power state. The actuator mechanism further includes an extension arm that extends from the power switch in a substantially horizontal direction. Responsive to a user toggling the remote power switch from the first power state to the second power state, the extension arm rotates to activate or deactivate the power switch fixedly attached to the wall.

Particular implementations can include one or more of the following advantages. Until now, nothing on the market has been made or designed to allow the operation of a light switch located behind a piece of furniture or appliance. Now anyone moving furniture or appliances can place these items wherever they desire without the concern of a poorly placed light switch forcing them to find alternative locations for their items. Not being able to place a piece of furniture or appliance in a particular location because of a poorly placed light switch is and has always been a problem for most everyone. One advantage of the present invention is the elimination of such a problem.

The details of one or more implementations are set forth in the accompanying drawings and the description below. Other features and advantages will be apparent from the description and drawings, and from the claims.

### BRIEF DESCRIPTION OF SEVERAL VIEWS OF THE DRAWINGS

FIG. 1 illustrates a conventional room including a power switch.

FIG. 2 illustrates the room of FIG. 1 including a bookshelf blocking the power switch.

FIGS. 3A-3B illustrate an actuator mechanism for activating a power switch in accordance with one implementation.

FIG. 4 illustrates a room including the actuator mechanism of FIGS. 3A-3B.

FIGS. 5A-5B illustrate an actuator mechanism for activating a power switch in accordance with one implementation.

FIGS. 6A-6C illustrate an actuator mechanism for activating a power switch in accordance with one implementation.

FIG. 7 illustrates an actuator mechanism for activating a power switch in accordance with one implementation.

FIG. 8 illustrates an actuator mechanism for activating a power switch in accordance with one implementation.

FIG. 9 illustrates an actuator mechanism for activating a power switch in accordance with one implementation

FIG. 10 illustrates a dimmer switch in accordance with one implementation.

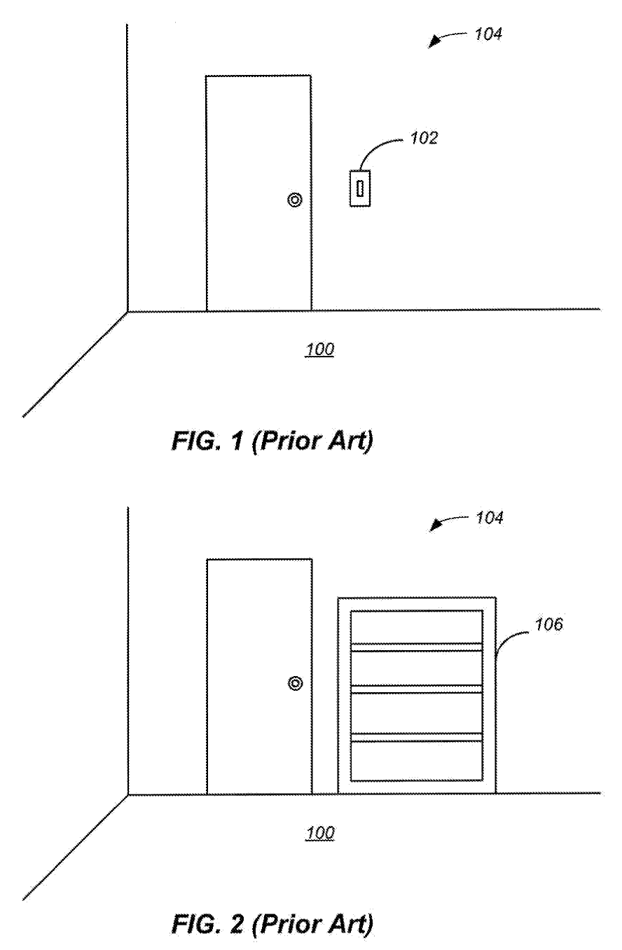

Like reference symbols in the various drawings indicate like elements.

### DETAILED DESCRIPTION OF THE INVENTION

Implementations of the present invention relates to techniques for activating a toggle power switch. The following description is presented to enable one of ordinary skill in the art to make and use the invention and is provided in the context of a patent application and its requirements. The present invention is not intended to be limited to the implementations shown but is to be accorded the widest scope consistent with the principles and features described herein.

Presented below are five implementations of an actuator mechanism for activating a power toggle switch. Each of the five implementations of the actuator mechanism is designed to operate a particular type of power toggle switch.

### Toggle Switch Actuator

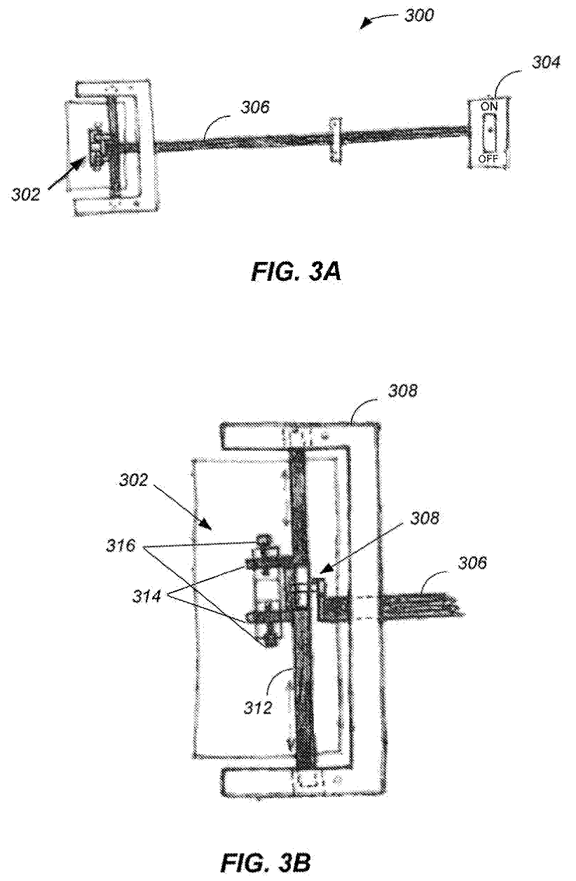

FIG. 3A illustrates an actuator mechanism 300 operable to activate a power toggle switch 302. In one implementation, the power toggle switch 302 operates in a vertical manner in which a person toggles (or flips) the power toggle switch 302 in an up position to activate the switch and toggles the power toggle switch in a downward direction to deactivate the switch (or vice versa). In one implementation, the actuator mechanism 300 includes a remote switch 304 (that is separate from the power toggle switch 302) and an extension arm 306. In one implementation, the remote switch 304 is portable in that the remote switch 304 can be located at a desired location on a wall. In one implementation, the extension arm 306 is made of wood, however, in general, the extension arm can be made of any suitable material (e.g., plastic or metal). In one implementation, the extension arm 306 extends from the power toggle switch 302 in a substantially horizontal direction (e.g., 0-+/−30 degrees), unlike conventional extension arms that may extend from a power toggle switch in a vertical direction (e.g., to permit a young child to turn on/off the power toggle switch). The extension of the extension arm 306 in a substantially horizontal direction away from the power toggle switch 302 permits a person to maintain access to the power toggle switch 302 (via the remote switch 304) even though an item (e.g., furniture or appliance) is placed in front of the power toggle switch 302 In one implementation, a length of the extension arm 306 is manually adjustable to permit a user to easily extend or contract the length of the extension arm.

In one implementation, a person positioning (e.g., pressing down on) the remote switch 304 to a given power state (e.g., to an “On” or “Off” position) causes the extension arm 306 to turn (or rotate) approximately one quarter of an inch. As shown in FIG. 3B, the extension arm 306 extends through a brace 308 (e.g., made of plexi-glass or other material) that surrounds the power toggle switch 302. At the end of the extension arm 306 is a pin 310 (e.g., made of steel or other material). As the extension arm 306 is rotated, the pin causes a (wooden) slide arm 312 to move either up or down based on the direction the extension arm 306 is rotated. Two small (plexi-glass) arms 314 extend from the center of the slide arm 312. The plexi-glass arms 314 are placed so that they straddle the power toggle switch 302. Attached to each of the plexi-glass arms 314 is an adjusting screw 316. In one implementation, the adjusting screws 316 are designed to adjust by hand. The adjusting screws 316 can be adjusted until they almost contact the power toggle switch 302 on both sides, as shown in FIG. 3B. As the wooden slide arm 312 is moved up or down the wooden slide arm 312 causes the plexi-glass arms 314 (with the attached adjusting screws 316) to flip the power toggle switch 302 on or off dependent on the direction that the slide arm is moved which is operated by the extension arm 306 attached to the remote switch 304 (e.g., a push button switch).

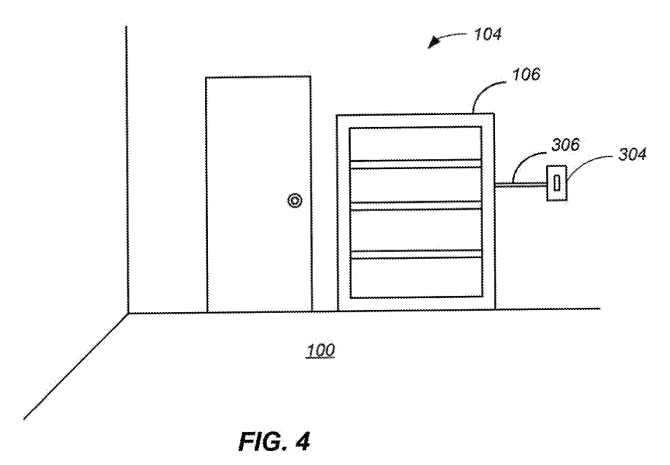

FIG. 4 illustrates the room 104 including the book shelf 106 and the actuator mechanism 300. As shown in FIG. 4, the toggle power switch (located behind the book shelf 106) is accessible via the remote switch 304. The actuator mechanism 300, therefore, permits a user items in front of the toggle power switch while providing access to the toggle power switch.

### Push Button Actuator

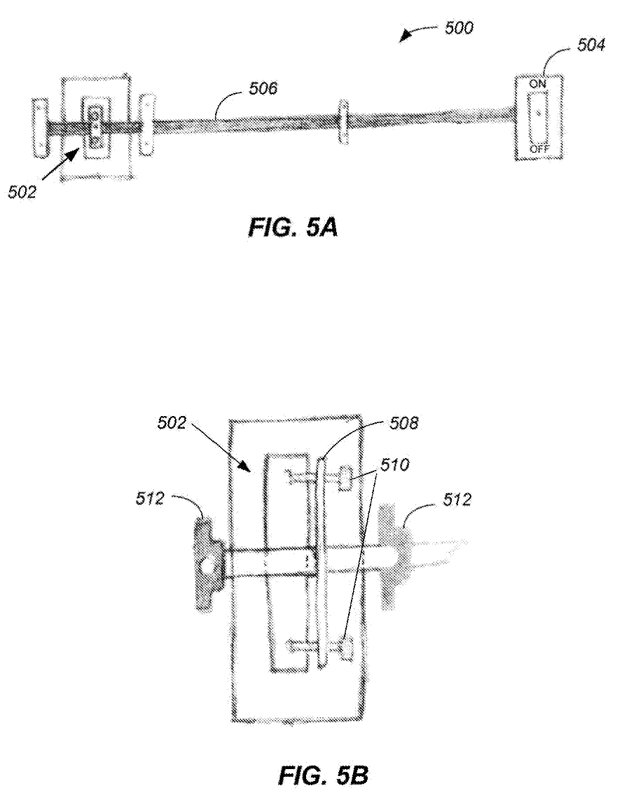

FIG. 5A illustrates an actuator mechanism 500 operable to activate a push button switch 502. In one implementation, the push button switch 502 operates in a vertical manner in which a person depresses an end of the push button switch 502 to activate the switch and depresses the other end of the push button switch 502 to deactivate the switch (or vice versa). In one implementation, the actuator mechanism 500 includes a remote switch 504 and an extension arm 506. In one implementation, the extension arm 506 extends from the push button switch 502 in a substantially horizontal direction. In operation, pushing down on the remote switch 504 causes the extension arm 506 attached to the remote switch 504 to rotate (e.g., approximately one quarter inch). As shown in FIG. 5B, attached to end of the extension arm 506 is a small (plexi-glass) arm 508 that straddles the extension arm 506. The small (plexi-glass) arm 508 has an adjusting screws 410 attached to each end of the (plexi-glass) arm 508. In one implementation, the adjusting screws 510 are turned by hand until they almost contact the push button switch 502 on both ends. As the extension arm 506 rotates back and forth, as a user presses the remote switch 504 to the “on” and “off” positions, the (plexi-glass) arm 508 and the adjusting screws 510 cause the push button switch 502 to be activated. The extension arm 506 can be supported by mounting brackets 512.

### Toggle Switch Actuator (Drop Down Implementation)

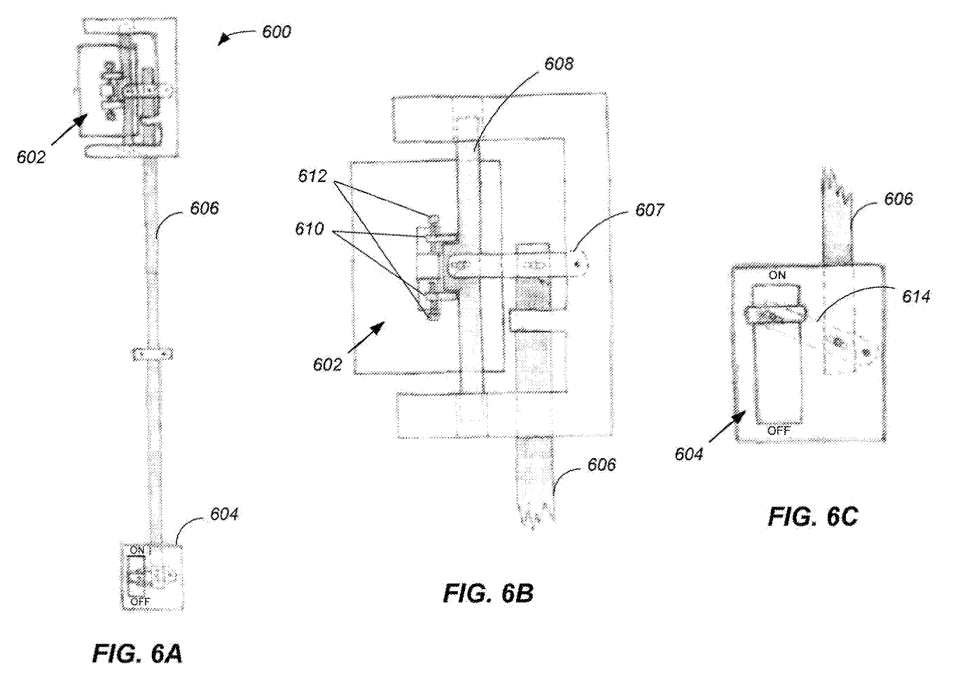

FIG. 6A illustrates an actuator mechanism 600 operable to activate a power toggle switch 602. The actuator mechanism 600 operates similar to the actuator mechanism 300 discussed above, however, the actuator mechanism 600 includes an extension arm (e.g., extension arm 606) that extends from the power toggle switch 602 in a vertical direction. Accordingly, in one implementation, the actuator mechanism 600 includes a remote switch 604 and an extension arm 606. In operation, the extension arm 606 moves up and down in response to a user pressing the remote switch 604 to the “on” and “off” positions. As shown in FIG. 6B, an actuator slide bar 608 is connected to the extension arm 606 (via a pivot arm 607), and the actuator slide bar 608 moves up and down relatively in sync with movement of the extension arm 606. In one implementation, two small (plexi-glass) arms 610 are attached to the actuator slide bar 608. The (plexi-glass) arms 610 actuate the power toggle switch 602 through contact with small, adjustable pivot screws 612. As shown in FIG. 6C, in one implementation, the remote switch 604 is connected to the extension arm 606 through a pivot arm 614.

### Push Button Actuator (Drop Down Implementation)

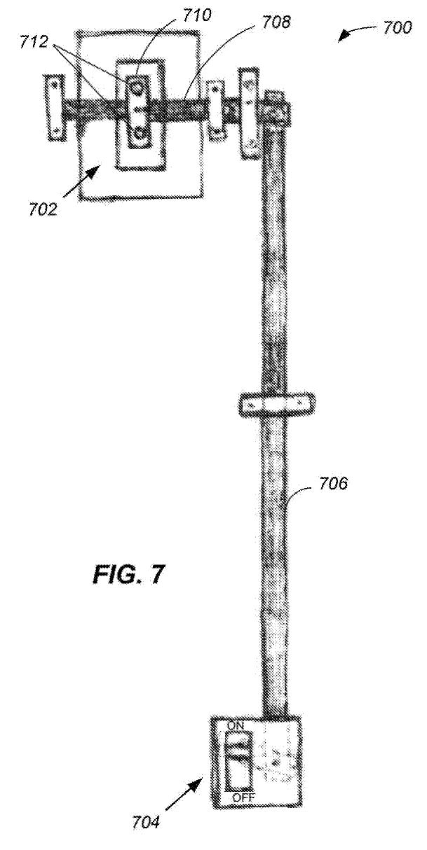

FIG. 7 illustrates an actuator mechanism 700 operable to activate a push button switch 702. The actuator mechanism 700 operates similar to the actuator mechanism 500 discussed above, however, the actuator mechanism 700 includes an extension arm (e.g., extension arm 706) that extends from the push button switch 702 in a vertical direction. In one implementation, the actuator mechanism 700 includes a remote switch 704 and an extension arm 706. In operation, as the extension arm 706 is forced up or down dependent upon movement of the remote switch 704. Thus, as the extension arm 706 travels up or down, the extension arm 706 causes a rod 708 (attached to the extension arm 706) to turn either left or right (e.g., approximately one-quarter of an inch). In one implementation, a small (plexi-glass) arm 710 straddles the rod 708. Attached to each end of the plexi-glass arm 710 is a small metal adjusting screw 712. In one implementation, the adjusting screws 712 are adjusted by hand until they almost contact the push button switch 702. As the plexi-glass arm 710 is turned left or right by the up or down movement of the rod 708, the plexi-glass arm 710 causes metal adjusting screws 712 to activate (or depress) the push button switch 702.

### Toggle Switch Actuator (Flush-Mount Implementation)

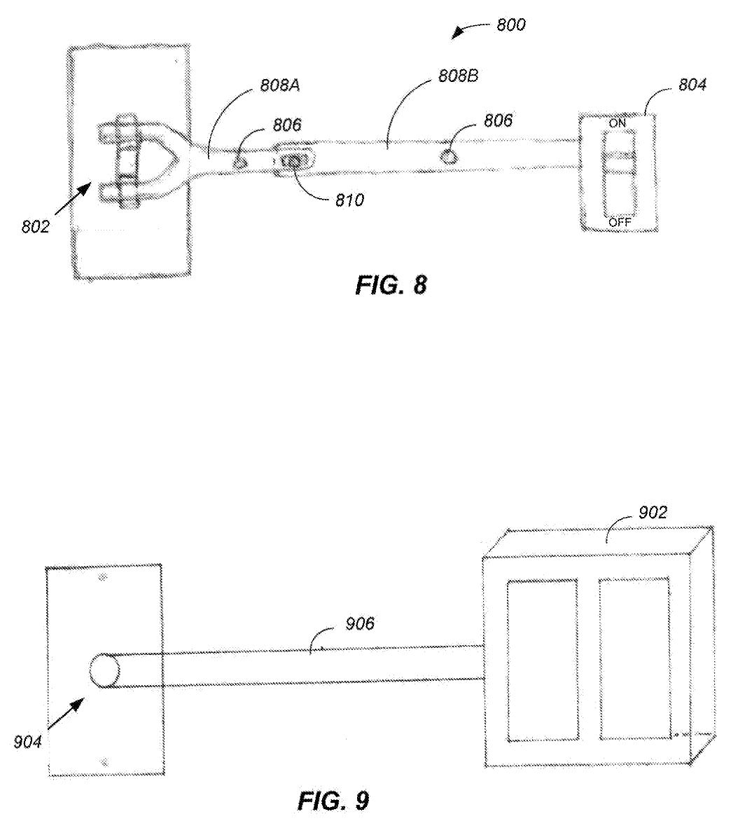

FIG. 8 illustrates an actuator mechanism 800 operable to activate a power toggle switch 802 via a remote switch 804. In one implementation, the actuator mechanism 800 includes components that are primarily constructed out of plexi-glass, with a few small metal pivots. The design utilizes strategically placed pivot points (e.g., pivot points 806) to accomplish the goal of activating the power toggle switch 802. In one implementation, the actuator mechanism 800 includes two arms—a first arm 808A and a second arm 808B. In one implementation, the first arm 808A has a small fork at one end. When mounted on a wall with a small metal pivot screw 810, the first arm 808A is placed so that the small fork end straddles the power toggle switch 802. The pivot screw 810 is placed near the center of the fork arm. Attached to the other end of the fork arm, by means of another pivot 806, is an adjustable length arm—i.e., the second arm 808B. The second arm 808B also includes a metal pivot screw 806 placed substantially in the center of the second arm 808B. In one implementation, the pivot screws 806 respectively attach the first arm 808A and the second arm 808B to the wall. Once the desired length has been determined, the second arm 808B can be cut and attached to the remote switch 804.

In operation, as the remote switch 804 is moved either up (e.g., to the “on” position) or down (e.g., to the “off” position), the remote switch 804 causes the second arm 808B to pivot either up or down on the attached pivot screw 806. As the second arm 808B pivots up or down the second arm 808B causes the first arm 808A to pivot up or down on a corresponding attached pivot screw 806. As the first arm 808A pivots up or down while straddling the power toggle switch 802, the first arm 808A activates the power toggle switch 802 consistent with movement of the remote switch 804.

### Electrical Implementation

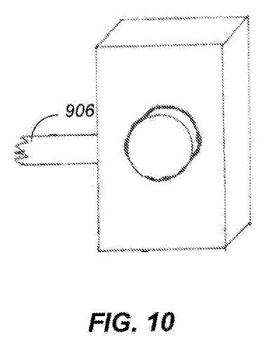

In one implementation, a low profile electrical light switch can be remotely located to provide access to a fixed power switch. FIG. 9 illustrates an electrical light switch 900 in accordance with one implementation. The electrical light switch 900 can comprise single, dual or triple push buttons and/or a dimmer switch (as shown in FIG. 10). In one implementation, the electrical light switch 900 is self-contained and can be easily attached to most surfaces by screws (e.g., wood screws, drywall screws, and so on), or double-sided tape. As shown in FIG. 9, the electrical light switch 900 includes a remote power switch 902 that can activate a power switch 904 through a coaxial cable.

To implement the electrical light switch 900, the old light switch can be removed completely from the wall, and the electrical wiring remaining in the wall from the old switch can be connected to (e.g., color coded wiring) associated with the electrical light switch 900. In one implementation, before connecting the remote power switch 902 to the electrical wiring, the electrical wiring is threaded through a protective light switch cover 906. The cover can be similar in appearance to the wall covers used with the coaxial cable. In one implementation, a plain plastic cover with a small one-quarter inch hole in the center is used to cover the area where the old light switch was removed to allow the new wiring access for connection. The color coded wiring is first cut to the desired length. The desired length is determined by the placement of the remote power switch 902 and extends over to the protective light switch cover 906 and attaches to the center hole. Once the location of the remote power switch 902 is determined, the tubing and the wiring are cut to accommodate the distance from the remote power switch 902 to the old light switch location. Once the remote power switch 902 is mounted, the color coded wiring is threaded through the attached tubing and cover, then connected to the old wiring.

Although the present invention has been described in accordance with the implementations shown, there could be variations to the implementations. For example, other suitable fabrication materials can be used in lieu of those discussed above. In addition, although the implementations discussed above show a mechanical connection between a remote power switch and a corresponding power switch, the connection between the two units can be a wireless connection. In such an implementation, the remote power switch can be located at any location in a room and still activate a power switch located on a wall. Accordingly, many modifications may be made without departing from the scope of the present invention, the scope of which is defined by the following claims.

1. An actuator mechanism for activating an existing power switch fixedly attached to a wall, the actuator mechanism comprising:
a remote power switch that is portably locatable on the wall separate from the existing power switch that is fixedly attached to the wall along a common wall surface, the remote power switch operable to be toggled to a first power state and a second power state;
an extension arm, coupled to the remote power switch, the extension arm configured to extend from the power switch in a substantially horizontal direction;
wherein responsive to a user toggling the remote power switch from the first power state to the second power state, the extension arm rotates to activate or deactivate the existing power switch fixedly attached to the wall.

2. The actuator mechanism of claim 1, wherein a length of the extension arm is manually adjustable in accordance with a desired spatial distance along the common wall surface.

3. The actuator mechanism of claim 1, wherein a toggle switch of the remote power switch is movable in the same manner as a toggle switch of the existing power switch.

4. The actuator mechanism of claim 3, wherein the toggle switch of the remote power switch is movable in an up and down manner, the extension arm is movable in a rotating manner, and the toggle switch of the existing power switch is movable in an up and down manner.

5. An actuator mechanism for activating an existing power switch fixedly attached to a wall, the actuator mechanism comprising:
means for remote power switching that is portably locatable on the wall separate from the existing power switch that is fixedly attached to the wall along a common wall surface, the means for remote power switching operable to be toggled to a first power state and a second power state;
means for extending, coupled to the means for remote power switching, the means for remote power switching configured to extend from the existing power switch in a substantially horizontal direction;
wherein responsive to a user toggling the means for remote power switching from the first power state to the second power state, the means for extending rotates to activate or deactivate the existing power switch fixedly attached to the wall.

6. The actuator mechanism of claim 5, wherein a length of the means for extending is manually adjustable in accordance with a desired spatial distance along the common wall surface.

7. The actuator mechanism of claim 5, wherein a toggle switch of the means for remote switching is movable in the same manner as a toggle switch of the existing power switch.

8. The actuator mechanism of claim 7, wherein the toggle switch of the means for remote switching is movable in an up and down manner, the means for extending is movable in a rotating manner, and the toggle switch of the existing power switch is movable in an up and down manner.
